(19) United States
(12) Patent Application Publication
(10) Pub. No.: US 2005/0051924 A1
(43) Pub. Date: Mar. 10, 2005

(54) Process of making extruded knit materials

(76) Inventors: Paul Schmidt, Pretty Prairie, KS (US); Nick M. Carter, Mooresville, NC (US); Jennifer Mayhorn, Huntersville, NC (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/891,207

(22) Filed: Jul. 14, 2004

Related U.S. Application Data
(60) Provisional application No. 60/487,676, filed on Jul. 16, 2003.

(51) Int. Cl. B29C 47/00

(52) U.S. Cl. 264/211.12; 425/131.1; 264/211.23

(57) ABSTRACT

The present invention generally relates to the process of making extruded knit materials in a continuous manner, and more specifically, to an in-line process utilizing a compound extrusion manifold comprising three or more rotary die assemblies for continuously extruding three or more polymeric filaments into a functional knit material suitable for bale wrap, cargo wrap, netted bags, drainage nets, and the like. The in-line process incorporates three or more rotary die assemblies, wherein each rotary die assembly comprises at least one extrusion orifice that is positioned within each of the individual dies so as upon rotation of each of the dies the continuously extruded filaments become intermingled and interlocked.

### TECHNICAL FIELD

The present invention generally relates to the process of making extruded knit materials in a continuous manner, and more specifically, to an in-line process utilizing a compound extrusion manifold comprising three or more rotary die assemblies for continuously extruding three or more polymeric filaments into a functional knit material suitable for bale wrap, cargo wrap, netted bags, drainage nets, and the like.

### BACKGROUND OF THE INVENTION

The extrusion process is known in the art for the manufacture of nets and net-like materials. In accordance with the teachings of British Patent Specification No. 836,556, hereby incorporated by reference, plastic materials are initially extruded in tubular form using an apparatus comprised of a counter-rotating concentric pair of circular dies each having a circular series of spaced extrusion die orifices with the dies themselves being radially spaced apart to define a narrow annular gap between the respective sets of die orifices. With this arrangement, a thin film or membrane can be continuously extruded through the narrow annular gap integrally with a netting structure extruded through the die orifices and comprise a first set of paralleled strands on one face of the membrane and a second set of paralleled strands on the opposite face of the membrane, whereby each set of strands extends obliquely to the direction of extrusion and joined at their cross points by integral intersections.

Nets may also be prepared either by knitting or by weaving. In the case of a knitted net, a typical net will comprise a plurality of threads oriented in a first direction and being essentially equal spaced from one another, and having wefts oriented in a second direction which is perpendicular to the first direction, the threads and wefts being interlocked and secured. Nets may be prepared by a Raschel knitting method, a complex and time consuming process in which the filaments are attached to knitting elements which comprise two needles and knock-over comb bars which are positioned opposite to one another, and comprising ground guide bars, pattern guide bars and stitch comb bars. An example of such a knitted net is described in European Patent No. 0 723 606, to Fryszer, et al., incorporated herein by reference. A process for making woven netting is complex as well, whereby the polymeric strands are designated for specific use as warp or fill strands. Further, the pre-processed polymeric strands need to be wound onto a loom beam, which is then mounted onto the back of the loom to produce yardage of netting.

The aforementioned knitting and weaving processes are complicated, time consuming, and costly due to the multiple steps involved in setting up the extensive equipment. A need remains for a more efficient process of making knitted nets by simplified and expedient means.

### SUMMARY OF THE INVENTION

The present invention generally relates to the process of making extruded knit materials in a continuous manner, and more specifically, to an in-line process utilizing a compound extrusion manifold comprising three or more rotary die assemblies for continuously extruding three or more polymeric filaments into a functional knit material suitable for bale wrap, cargo wrap, netted bags, drainage nets, and the like. The in-line process incorporates three or more rotary die assemblies, wherein each rotary die assembly comprises at least one extrusion orifice that is positioned within each of the individual dies so as upon rotation of each of the dies the continuously extruded filaments become intermingled and interlocked.

An embodiment of the present invention includes a centrally located rotary die that is accompanied on either side by one or more rotary die assemblies. The centrally located die rotates while extruding a continuous filament that acts to interlock the extruded filaments dispensed from the adjacent rotating dies, to form a continuously extruded net.

In accordance with the present invention, each of the rotary dies may incorporate more than one extrusion orifice placed within the die so as to plait the continuously extruded filaments. The rotary dies may include orifices of dissimilar shapes or profiles so as to extrude filaments of varying cross-sections, such that for example one of the rotary dies, or one of the extrusion orifices with a rotary die comprising multiple extrusion orifices may extrude a filament that is circular in cross-section, while another extrusion orifice extrudes a flat, tape-like filament. The filaments may be of similar or dissimilar polymeric compositions. Suitable filaments, which may be blended in whole or part with natural or synthetic polymeric compositions, include polyamides, polyesters, polyolefins, polyvinyls, polyacrylics, and the blends or coextrusion products thereof. The synthetic polymers may be further selected from homopolymers; copolymers, conjugates and other derivatives including those thermoplastic polymers having incorporated melt additives or surface-active agents.

Further, the compound extrusion manifold may incorporate the use of one or more stationary dies, whereby two or more rotary dies rotate about one or more centrally located stationary dies. Again, the stationary die(s) may include more than one extrusion orifice of optionally dissimilar shapes so as to extrude filaments of varying cross-sections. Each of the rotary dies themselves are driven by a motorized force that rotates the rotary dies in unison within the compound extrusion manifold. While the rotary dies rotate in set relationship with one another, the extruded filaments are plaited to form a net material.

In one embodiment, the rotary die may accept a stack plate die insert. Co-pending application U.S. Ser. No. 60/462,054, filed Apr. 11, 2003 to Krause, et al., teaches to such stack plate die, which is hereby incorporated by reference. The stack plate die insert may be utilized alone or in combination with additional rotary and/or stationary dies. Furthermore, a single rotary die may comprise the stack plate insert as well as one or more additional orifices for filament extrusion.

It is within the purview of the present invention that the rotary dies may be similar or dissimilar in shape. In a preferred embodiment, the rotary dies are circular in circumference; however the rotary dies may be oval or of other peripheral profiles. It is believed that the various rotary die shapes, in addition to the extruded filament compositions and cross-sections, contribute to the over all plaiting pattern of the filaments, affecting the physical properties of the net material.

The multiple rotary die, compound extrusion manifold of the present invention processes a net material in-line without the need for separate knitting and weaving operations. A process for making a net material in accordance with the present invention entails extruding continuous filaments and optionally twisting or plaiting the filaments as the filaments are extruded from the rotary dies, whereby one or more rotary dies perform to interlock the surrounding filaments. Subsequently, the interlocked filaments are quenched, drawn, and wound, which results in a continuously extruded net material that can be produced at a faster rate of speed.

### BRIEF DESCRIPTION OF THE DRAWINGS

FIG. 1 is a schematic representation of the processing apparatus for producing a net material in accordance with the principles of the present invention;

FIG. 2 is a schematic representation of an embodiment of the rotary die head utilized in accordance with the present invention;

FIG. 3 is a schematic representation of an embodiment of the rotary die head utilized in accordance with the present invention;

FIG. 4 is a schematic representation of an embodiment of the rotary die head utilized in accordance with the present invention;

FIG. 5 is a schematic representation of an embodiment of the rotary die head utilized in accordance with the present invention;

FIG. 6 is a schematic representation of an embodiment of the rotary die head utilized in accordance with the present invention;

FIG. 7 is a schematic representation of an embodiment of the rotary die head utilized in accordance with the present invention;

FIG. 8 is a schematic representation of an embodiment of the rotary die head utilized in accordance with the present invention;

FIG. 9 is a schematic representation of an embodiment of the rotary die head utilized in accordance with the present invention;

FIG. 10 is a schematic representation of an embodiment of the rotary die head utilized in accordance with the present invention; and

FIG. 11 is a schematic representation of a net material made in accordance with the present invention;

FIG. 12 is a schematic representation of an embodiment of the rotary die assemblies utilized in accordance with the present invention;

FIG. 13 is a schematic representation of an embodiment of the rotary die assemblies utilized in accordance with the present invention; and

FIG. 14 is a schematic representation of an embodiment of the rotary die assemblies utilized in accordance with the present invention.

### DETAILED DESCRIPTION

While the present invention is susceptible of embodiment in various forms, there will hereinafter be described, presently preferred embodiments, with the understanding that the present disclosure is to be considered as an exemplification of the invention, and is not intended to limit the invention to the specific embodiments disclosed herein.

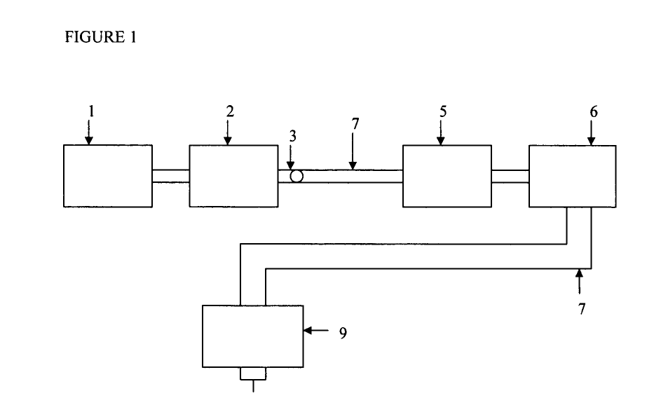

FIG. 1 depicts a representative direct extrusion film process. Blending and dosing system 1, comprising at least two hopper loaders for polymer chip and a mixing hopper. Variable speed augers within both hopper loaders transfer predetermined amounts of polymer chip and additive pellet to the mixing hopper. The mixing hopper contains a mixing propeller to further the homogeneity of the mixture.

The polymer chip and additive pellet blend feeds into a multi-zone extruder 2 as supplied by the Wellex Corporation. In this particular system, a five zone extruder was employed with a 2 inch water-jacketed bore and a length to diameter ratio of 24 to 1.

Upon mixing and extrusion from multi-zone extruder 2, the polymer compound is conveyed via heated polymer piping 7 through screen changer 3, wherein breaker plates having different screen meshes are employed to retain solid or semi-molten polymer chips and other macroscopic debris. The mixed polymer is then fed into melt pump 5.

Melt pump 5 operates in dynamic feed back with the multi-zone extruder 2 to maintain the desired pressure levels. A gear-type melt pump was employed to respond to pressure levels by altering the speed of the extruder to compensate for deviations from the pressure set point window.

The metered and mixed polymer compound then enters combining block 6. The combining block allows for multiple film layers to be extruded, the film layers being of either the same composition or fed from different systems as described above. The combining block 6 is directed into rotary die body 9 by additional heated polymer piping 7.

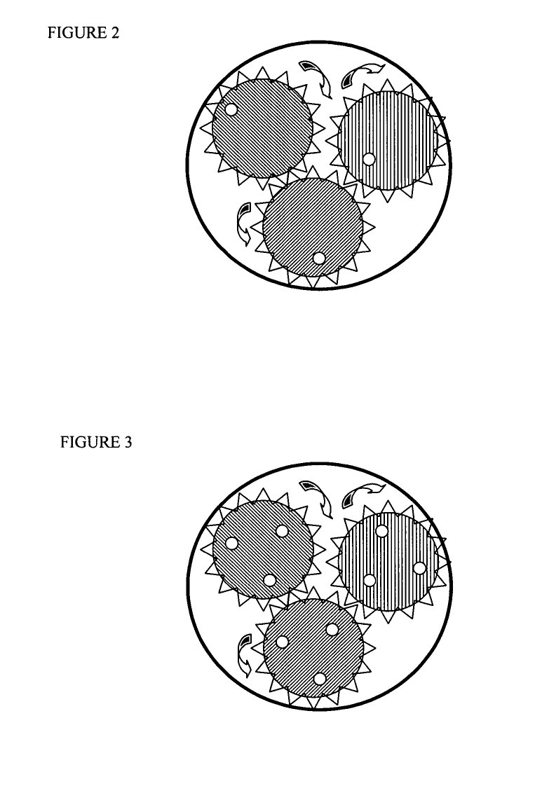

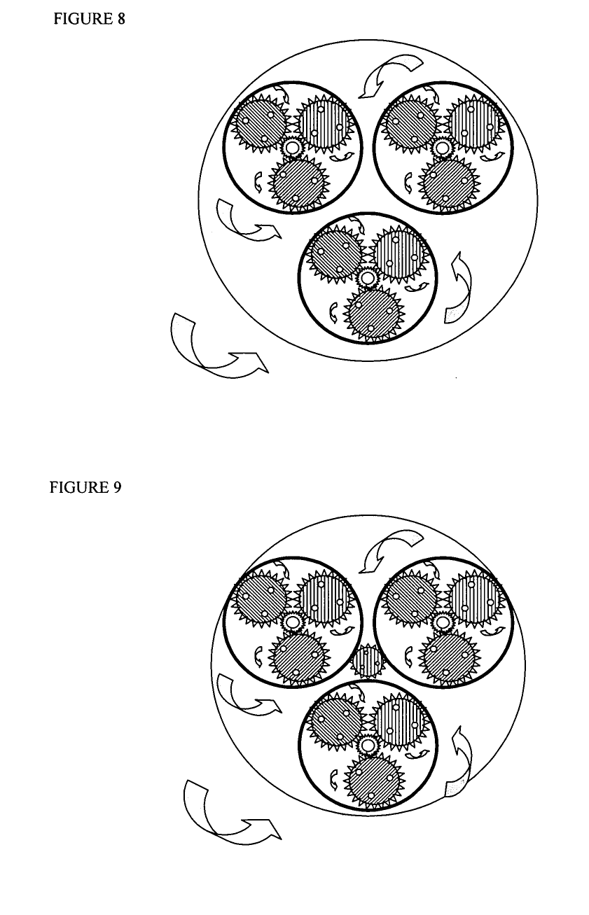

The various die bodies that may be employed in this system are illustrated in FIGS. 2-10. The rotary die body embodiment represented in FIG. 2 illustrates three rotary dies, each with a single extrusion orifice exit, wherein the three rotary dies rotate in unison by a driving force that encompasses the periphery of the rotary dies. Suitable driving force means include, but are not limited to motorized belts, chains, and pulley systems. It has been contemplated that each rotary die comprise more than one extrusion orifice exit. FIG. 3 is representative of such an embodiment.

It is within the purview of the present invention that each rotary die may extrude continuous filaments of similar composition or dissimilar composition. Suitable synthetic filaments, which may be blended in whole or part, include polyamides, polyesters, polyolefins, polyvinyls, polyacrylics, and the combinations thereof. The polymers may be further selected from homopolymers; copolymers, conjugates and other derivatives including those thermoplastic polymers having incorporated melt additives or surface-active agents. In addition, each extrusion orifice may extrude a continuous filament of similar or dissimilar cross-sections, wherein one orifice may extrude a filament that is circular in cross-section, while another orifice extrudes a flat, tape-like filament.

FIG. 5 is a schematic representation of an embodiment of the rotary die of the present invention, wherein each rotary die is comprised of more than one extrusion orifice exit. Further, each extrusion orifice exit within each die comprises a dissimilar orifice shape so as to extrude continuous filaments of dissimilar cross-sections.

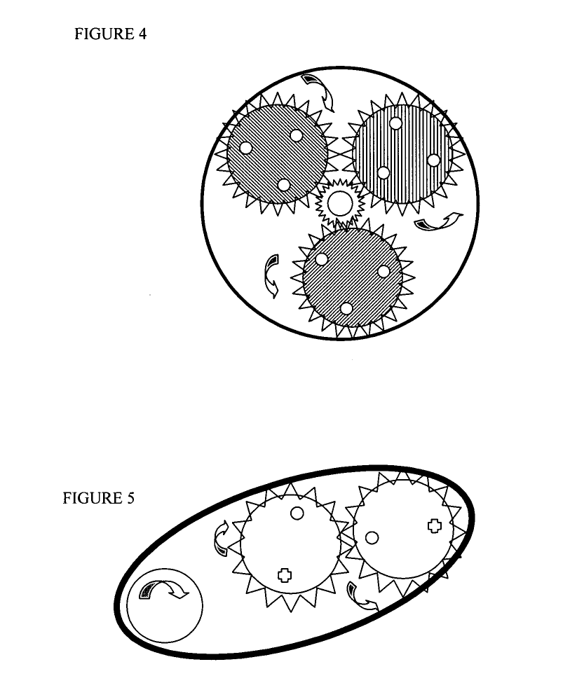

In one embodiment of the present invention, the rotary dies assemblies may be utilized in combination with one or more stationary dies. FIG. 4 illustrates the rotary dies of the present invention rotating in unison along a centrally located stationary die. In such an embodiment, the extruded continuous filaments dispensed from the rotary dies are plaited about a centrally extruded continuous filament. The various continuous filaments dispensed from the various dies may comprise a vast range of deniers, depending on the end-use of the processed net material. It has also been contemplated that the rotary dies of the present invention accept one or more stack plate die inserts. Further, the rotary dies may be used in combination with both stationary dies and stack plate die inserts.

Utilizing a combination of rotary and stationary dies allows for the dissimilar dies to operate at variable speeds. Also, utilizing multiple rotary dies that operate independent from one another allows the individual rotary dies to operate at variable speeds. Advantageously, the frequency of the interconnecting extruded filaments can be manipulated thereby affecting the resultant net material to exhibit more or less extensibility depending on the desired end-use application.

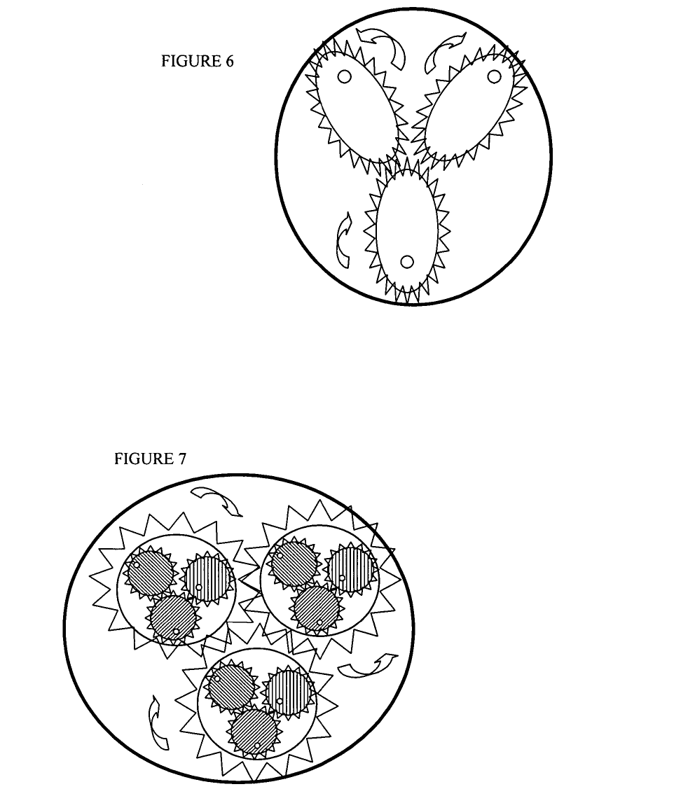

FIG. 6 depicts the use of non-circular shaped rotary dies. In accordance with the present invention the rotary dies may be of various shapes, whereby the rotary dies may all consist of the same shape or different shapes. Additionally, the rotary dies may be compounded as demonstrated in FIGS. 7-9. In this embodiment, plaited filaments extruded from each rotary die are plaited again to form a compoundly plaited net material.

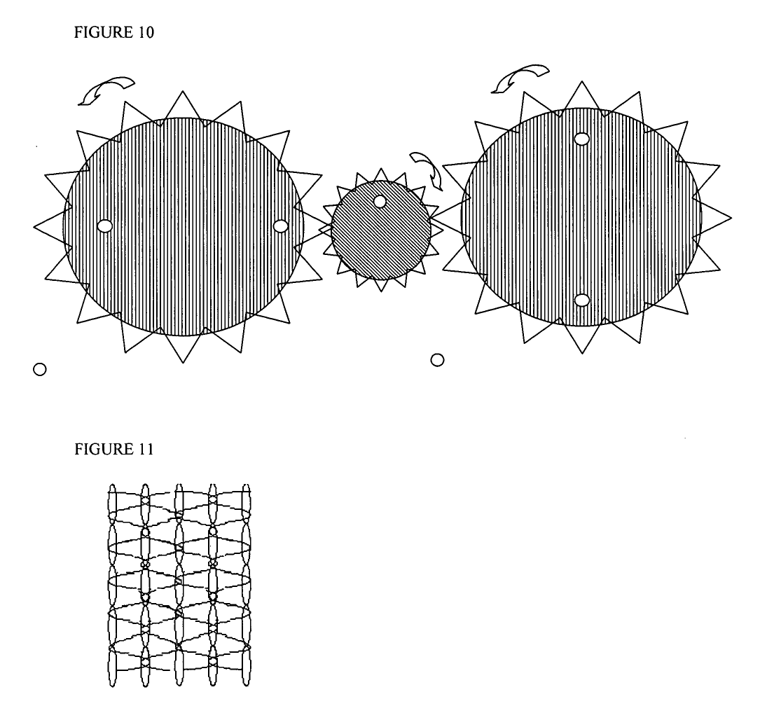

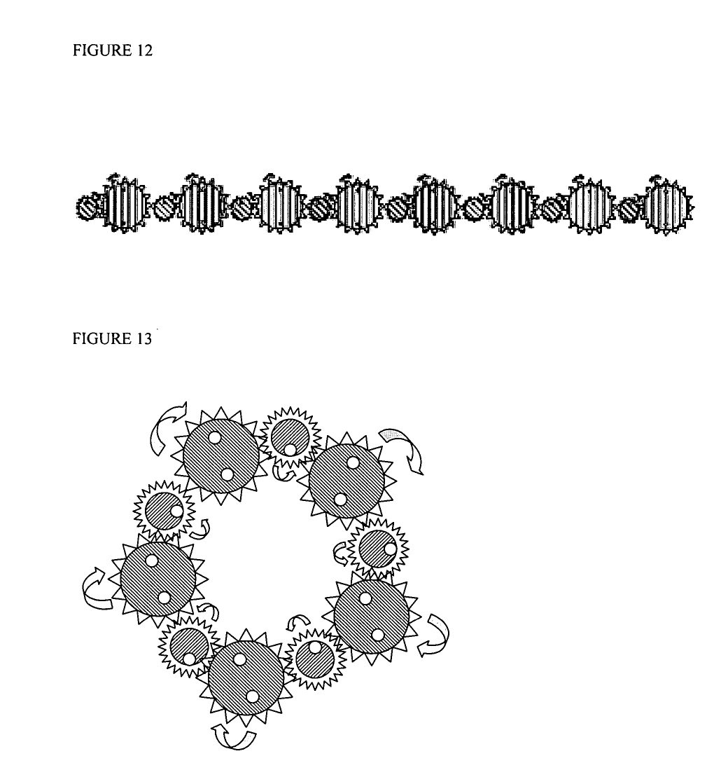

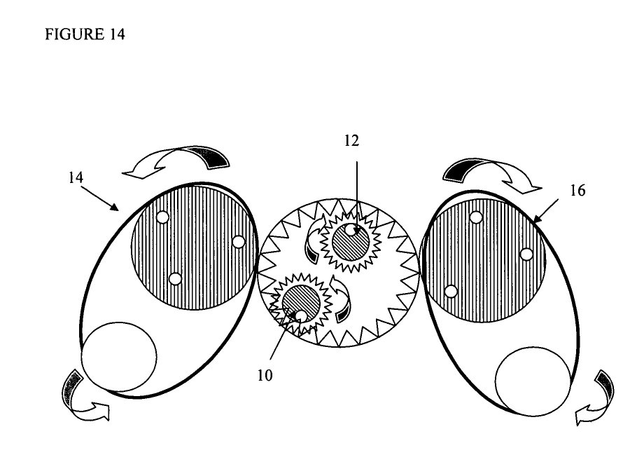

FIGS. 10 and 12 are representative of the multiple rotary die, compound extrusion manifold of the present invention for the net material illustrated in FIG. 11, whereby a centrally located rotary die extrudes a continuous filament that interlocks the filaments extruded from the adjacent rotary die assemblies. Further, the continuously extruded sheets of net material may be adjoined to one or more additional sheets of net material by way of an intermediate rotary die assembly that performs into interconnect two or more compound extrusion manifolds. It has also been contemplated that a tubular net material may be formed by arranging a series of rotary die assemblies in a circular formation, as shown in FIG. 13 or other essentially close-ended peripheral profiles. Again, with the inclusion of one or more intermediate rotary die assemblies, two or more tubular compound extrusion manifolds may be interconnected.

In another embodiment of the present invention, the rotary die assemblies may comprise primary die assemblies and secondary die assemblies. FIG. 14 illustrates secondary dies 10 and 12 operating independent of primary dies 14 and 16. The secondary die assemblies may follow a similar or dissimilar path than that of the primary die assemblies. Further, the secondary dies may travel at a similar or dissimilar rates compared to that of the primary dies. The independent secondary dies can be manipulated to acquire a desired characteristic in the resultant net material. For example, the secondary dies may operate to follow and reinforce selected extruded filaments dispensed from a specific primary die assembly. The rate at which the secondary dies travel may also affect how tightly the primary die filaments are interconnected, resulting is more or less extensible net material.

Subsequent to formation, the net material may optionally be subjected to various chemical and/or mechanical post-treatments. The net material is then collected and packaged in a continuous form, such as in a roll form, or alternatively, the net material may comprise a series of weak points whereby desired lengths of twine material may be detracted from the remainder of the continuous packaged form.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

1. An apparatus for continuously extruding a net material in an in-line process wherein said apparatus comprises three or more rotary dies that extrude one or more polymeric resins through one or more extrusion orifice; said dies driven by a motorized force to rotate said dies in unison with one another extruding said polymeric resins into said net material.

2. An apparatus as in claim 1, wherein said rotary dies are arranged in a linear formation.

3. An apparatus as in claim 1, wherein said rotary dies are arranged in a non-linear formation.

4. An apparatus as in claim 1, wherein said rotary dies comprise a stationary die.

5. An apparatus as in claim 1, wherein said rotary dies comprise a stack plate die insert.

6. An apparatus as in claim 1, wherein said extrusion orifice extrude polymers of dissimilar cross-sections.

7. An apparatus as in claim 1, wherein said rotary dies are compounded.

8. A process for making a continuously extruded net material in-line comprising the steps of:
a. providing three or more rotary dies comprising at least one extrusion orifice, wherein said dies are rotated by a motorized force;
b. providing at least a one polymeric resin;
c. extruding said polymeric resin from said rotary dies thereby interlocking said polymeric resin into said net material; and
d. collecting said net material.

9. A process for making a continuously extruded net material as in claim 8, wherein said rotary dies are in a linear formation.

10. A process for making a continuously extruded net material as in claim 8, wherein said rotary dies are in a non-linear formation.

11. A process for making a continuously extruded net material as in claim 8, wherein said continuously extruded net material is a tubular formation.

12. A process for making two or more interconnected continuously extruded net materials in-line comprising the steps of:
a. providing three or more rotary dies, each comprising at least one extrusion orifice, wherein said dies are rotated by a motorized force;
b. providing an intermediate rotary die assembly;
c. providing at least a one polymeric resin;
d. extruding said polymeric resin from said rotating rotary dies thereby interlocking said polymeric resin into said net material; and
e. collecting said net material.

13. A process for making a continuously extruded net material in-line comprising the steps of:
a. providing at least two primary rotary dies assemblies, each comprising at least one extrusion orifice, wherein said dies are rotated by a motorized force;
b. providing at least one secondary rotary die assembly comprising at least one extrusion orifice;
c. providing at least a one polymeric resin;
d. extruding said polymeric resin from said rotary dies thereby interlocking said polymeric resin into said net material; and
e. collecting said net material.

14. A process for making a continuously extruded net material in-line as in claim 13, wherein said primary and secondary dies rotate at similar speeds.

15. A process for making a continuously extruded net material in-line as in claim 13, wherein said primary and secondary dies rotate at dissimilar speeds.
